(19) United States
(12) Patent Application Publication
(10) Pub. No.: US 2018/0137696 A1
(43) Pub. Date: May 17, 2018

(54) COMPUTER-READABLE RECORDING MEDIUM, LOADED/UNLOADED STATE DETERMINATION METHOD, AND LOADED/UNLOADED STATE DETERMINATION DEVICE

(71) Applicant: FUJITSU LIMITED, Kawasaki-shi (JP)

(72) Inventor: Kosei Takano, Fujimino (JP)

(73) Assignee: FUJITSU LIMITED, Kawasaki-shi (JP)

(21) Appl. No.: 15/795,493

(22) Filed: Oct. 27, 2017

(30) Foreign Application Priority Data
Nov. 11, 2016 (JP) 2016-221060

(51) Int. Cl. G07C 5/08; B60Q 9/00

(52) U.S. Cl. CPC G07C 5/0825; B60Q 9/00

(57) ABSTRACT

A computer-readable recording medium has stored therein a loaded/unloaded state determination program that causes a computer to execute a process including acquiring a period of time until a vehicle reaches a predetermined vehicle speed and determining that a cargo is loaded on the vehicle if the acquired period of time satisfies a predetermined condition.

### CROSS-REFERENCE TO RELATED APPLICATION

This application is based upon and claims the benefit of priority of the prior Japanese Patent Application No. 2016-221060, filed on Nov. 11, 2016, the entire contents of which are incorporated herein by reference.

### FIELD

The embodiments discussed herein are related to a loaded/unloaded state determination program, a loaded/unloaded state determination method, and a loaded/unloaded state determination device.

### BACKGROUND

A business truck with a predetermined weight or greater is legally requested to record driving information of a running vehicle, and hence, a technique for recording driving information of a vehicle has been known. For example, there is a technique to determine whether an operation related to behavior to record driving information of a vehicle, such as loaded state or unloaded state of a vehicle, is determined as valid or invalid, based on whether or not a current position of a vehicle is within a preset range where an operational input is allowed. Furthermore, there is a technique to provide a driver with recommendation on display, according to the result of computation based on data of signal such as rotational speed of an engine, an accelerator position, a vehicle speed, an amount of fuel consumption, or a vehicle weight. Moreover, there is a technique to determine a threshold to determine if the rotational speed of an engine is excessive or not, based on a recorded rotational speed of an engine and a road gradient, to compare the rotational speed of an engine of a vehicle with a threshold, and to inform that the rotational speed of an engine exceeds the threshold. Prior art example is disclosed in Japanese Laid-open Patent Publication No. 2013-171297, Japanese Laid-open Patent Publication No. 2009-074482, and Japanese Laid-open Patent Publication No. 2011-251584.

Meanwhile, when a driving situation of a vehicle such as a cargo truck is managed, whether or not a cargo is loaded on a vehicle may be determined. For the above-mentioned technique, whether a vehicle is loaded or unloaded is determined by using, for example, a vehicle mass measurement means or an unloaded state/loaded state determination means. For an unloaded state/loaded state determination means, for example, a loaded state/unloaded state switch has been known where an operation for switching between a cargo loaded state and a cargo unloaded state of a vehicle is input thereto.

However, in case of using loaded state/unloaded state switch, since the switch is operated by a driver manually, a driver could fail to operate, or purposely execute an erroneous operation of a loaded state/unloaded state switch or the like, so it is not possible to correctly determine whether a vehicle is loaded or not.

Furthermore, a driver's timing of operating a loaded state/unloaded state switch varies, from the time when a driver is approaching a cargo loading place such as a warehouse or a factory, to a point of time when cargo is loaded and starting to move from a cargo loading place. In particular, if stop and go of a vehicle are repeated around a cargo loading place to wait for cargo loading/unloading turn at the loading/unloading place, timing of driver's operation of a loaded state/unloaded state switch varies all the more. Therefore, a loaded state/unloaded state switch it is difficult to correctly identify the timing of loading or unloading of a vehicle.

Additionally, as provided in the above-mentioned technique, in particular, if a vehicle waits for a long period of time for loading/unloading, even in a configuration to determine whether an operation is valid or not by using positional data, it may be impossible to correctly identify the timing of loading or unloading. Although it is possible to correctly determine the timing when a loaded state/unloaded state of a vehicle is changed by using, for example, a vehicle mass measurement means, an available vehicle is limited to a vehicle that has such a means in advance.

### SUMMARY

According to an aspect of an embodiment, a non-transitory computer-readable recording medium having stored therein a loaded/unloaded state determination program that causes a computer to execute a process of acquiring a period of time until a vehicle reaches a predetermined vehicle speed from a first vehicle speed. Furthermore the loaded/unloaded state determination program that causes a computer to execute a process of determining that a cargo is loaded on the vehicle if the acquired period of time satisfies a predetermined condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a graph illustrating an example of a change of a vehicle speed;

FIG. 2 is a graph illustrating an example of a change of rotational speed of an engine;

FIG. 3 is a diagram illustrating an example of functional blocks of a loaded/unloaded state determination device in a first embodiment;

FIG. 4 is a diagram illustrating an example of a vehicle DB in a first embodiment;

FIG. 5 is a diagram illustrating an example of a determination result DB in a first embodiment;

FIG. 6 is a flowchart illustrating an example of a loaded/Unloaded state determination process in a first embodiment;

FIG. 7 is a diagram illustrating an example of functional blocks of a loaded unloaded state determination device in a second embodiment;

FIG. 8 is a diagram illustrating an example of a vehicle DB in a second embodiment;

FIG. 9 is a diagram illustrating an example of a determination result DB in a second embodiment;

FIG. 10 is a diagram illustrating an example of a spot DB in a second embodiment;

FIG. 11 is a flowchart illustrating an example of a loaded/unloaded state determination process in a second embodiment;

FIG. 12 is a diagram illustrating an example of functional blocks of a loaded/unloaded state determination device in a third embodiment;

FIG. 13 is a diagram illustrating an example of a vehicle DB in a third embodiment;

FIG. 14 is a diagram illustrating an example of a determination result DB in a third embodiment;

FIG. 15 is a flowchart illustrating an example of a loaded/unloaded state determination process in a third embodiment; and

FIG. 16 is a diagram illustrating a hardware configuration example of a loaded/unloaded state determination device.

### DESCRIPTION OF EMBODIMENT(S)

Preferred embodiments of the present invention will be explained with reference to accompanying drawings. Additionally, this invention is not limited by such embodiments. Furthermore, respective embodiments as described below may appropriately be combined as long as inconsistency is not caused thereby.

[a] First Embodiment

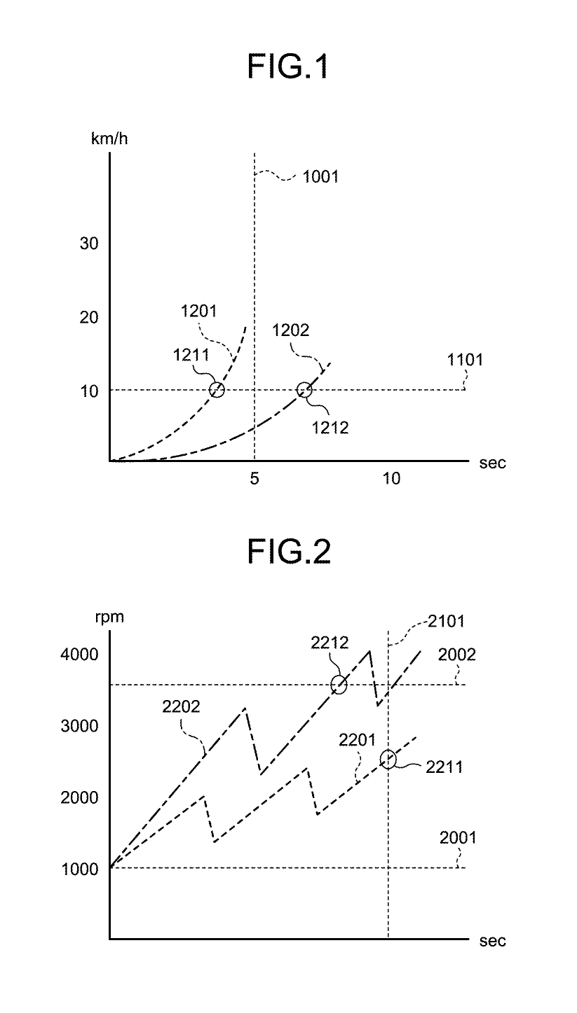

Hereinafter, a loaded/unloaded state determination process that is executed by a loaded/unloaded state determination device 100 will be described by using FIG. 1 to FIG. 16. In the following embodiments, for example, when a vehicle such as a truck reaches a predetermined vehicle speed, and if at least one of an acceleration time and rotational speed of an engine of such a vehicle is greater than or equal to a predetermined threshold, the loaded/unloaded state determination device 100 determines that a cargo is loaded on such a vehicle, namely, the vehicle is loaded. Furthermore, if both an acceleration time and rotational speed of an engine of a vehicle are less than predetermined thresholds, the loaded/unloaded state determination device 100 determines that a cargo is not loaded on such a vehicle; namely, the vehicle is unloaded. Additionally, an acceleration time is an example of a period of time until a vehicle reaches a predetermined vehicle speed from a first vehicle speed.

In the following embodiments, although a configuration will be described in such a manner that the loaded/unloaded state determination device 100 acquires both an acceleration time and rotational speed of an engine, this does not limit the example of configuration and a configuration may be provided in such a manner that only one of an acceleration time and a rotational speed of an engine is acquired to execute determination of a loaded or unloaded state. Furthermore, the loaded/unloaded state determination device 100 may be configured to determine that the vehicle is loaded, only if both an acceleration time and rotational speed of an engine satisfy the conditions.

The relationship between an acceleration time of a vehicle and a loaded state or unloaded state will be described by using FIG. 1. FIG. 1 is a graph illustrating an example of a change of a vehicle speed. In FIG. 1, a vertical axis represents a vehicle speed and a horizontal axis represents a time elapsed from the start of acceleration. Furthermore, in FIG. 1, a graph 1201 indicated by a broken line indicates a change of a speed of a vehicle that is unloaded and a graph 1202 indicated by a dashed-dotted line indicates a change of a speed of a vehicle that is loaded. Furthermore, a broken line 1001 indicates a predetermined threshold for an acceleration time and a broken line 1101 indicates a predetermined vehicle speed. In the present embodiment, a case will be described where a predetermined threshold for an acceleration time is “5 seconds” and a predetermined vehicle speed is “10 km/h”. Additionally, a predetermined threshold for an acceleration time is an example of a first threshold and may be represented by a “time threshold” below.

As illustrated in FIG. 1, an unloaded vehicle accelerates to a predetermined vehicle speed at a point of time 1211 before a time indicated by a time threshold is elapsed. That is, an acceleration time of an unloaded vehicle is less than a time threshold. On the other hand, compared with an unloaded vehicle, a loaded vehicle's period of time for accelerating to a predetermined vehicle speed are greater because of its cargo load, and hence, acceleration to a predetermined vehicle speed is executed at, for example, a point of time 1212 after a time indicated by a time threshold is elapsed. That is, an acceleration time of a loaded vehicle is greater than a time threshold.

Next, a relationship between rotational speed of an engine of a vehicle and a loaded state or unloaded state will be described by using FIG. 2. Additionally, a rotational speed of an engine of a vehicle may simply be represented by a “rotational speed of an engine” below. FIG. 2 is a graph illustrating an example of a change of a rotational speed of an engine. In FIG. 2, a vertical axis represents a rotational speed of an engine and a horizontal axis represents a time that is elapsed from the start of an acceleration. Furthermore, in FIG. 2, a graph 2201 indicated by a broken line indicates a change of a rotational speed of an engine of an unloaded vehicle and a graph 2202 indicated by a dashed-dotted line indicates a change of a rotational speed of an engine of a loaded vehicle. Additionally, a rotational speed of an engine rises at a time of acceleration but temporarily falls at a time of gear changing of a vehicle as indicated by the graphs 2201 and 2202.

In FIG. 2, a broken line 2001 indicates a rotational speed of an engine in a state where each vehicle is stopped, that is, the vehicle is in an idling state, and a broken line 2002 indicates a predetermined threshold for a rotational speed of an engine. In the present embodiment, a case will be described where a rotational speed of an engine in an idling state is “1,000 rpm”, and a predetermined threshold for a rotational speed of an engine is “3,700 rpm”. Additionally, in FIG. 2, it is assumed that any vehicle reaches a predetermined vehicle speed at a point of time before a time threshold indicated by a broken line 2101 in FIG. 2 is elapsed. Additionally, a predetermined threshold for a rotational speed of an engine is an example of a second threshold, and may be represented by a “rotational speed threshold” below.

In FIG. 2, as indicated by the graph 2201, an unloaded vehicle reaches a predetermined vehicle speed at a point of time 2211 while a rotational speed of an engine does not rise to a rotational speed threshold. On the other hand, compared with an unloaded vehicle, a loaded vehicle's power needed to accelerate is greater, and hence, if acceleration is executed within a certain period of time, a rotational speed of an engine tends to increase as compared with a rotational speed of an unloaded vehicle. Therefore, as indicated by the graph 2202, a rotational speed of an engine of a loaded vehicle at a time of acceleration rises to a rotational speed threshold at a point of time 2212 before reaching a predetermined vehicle speed.

Functional Blocks

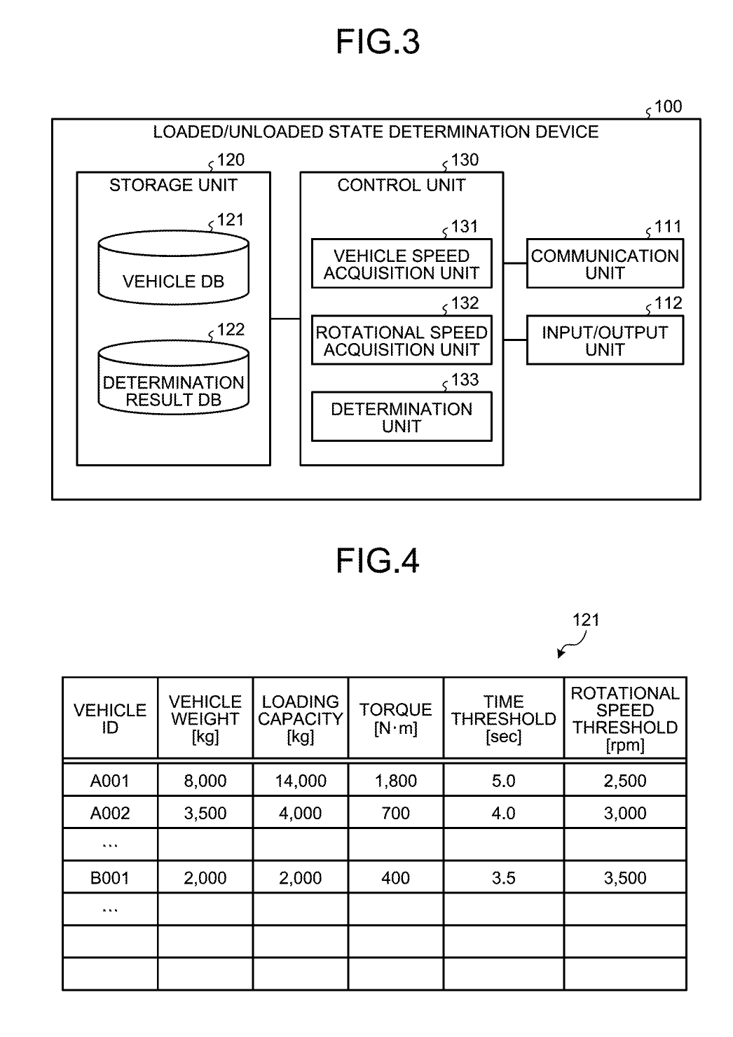

Next, a functional configuration in the present embodiment will be described. FIG. 3 is a diagram illustrating an example of functional blocks of a loaded/unloaded state determination device in a first embodiment. As illustrated in FIG. 3, a loaded/unloaded state determination device 100 in the present embodiment includes a communication unit 111, an input/output unit 112, a storage unit 120, and a control unit 130. Additionally, the loaded/unloaded state determination device 100 is realized by an instrument such as a computer and may include a variety of functional units that are included in a known computer, for example, functional units such as a variety of input devices or audio output devices, as well as functional units as illustrated in FIG. 3.

Furthermore, although the loaded/unloaded state determination device 100 is installed in, for example, an external server that is communicably connected to a vehicle such as a truck, this does not limit the example of configuration and the loaded/unloaded state determination device 100 may be realized by, for example, a computer mounted on a vehicle such as a truck. Furthermore, the loaded/unloaded state determination device 100 that is installed in an external server may execute a process by using information such as a vehicle speed or a rotational speed of an engine that is acquired by, for example, another means such as accessing to an external database, without directly communicating with such a vehicle.

The communication unit 111 controls communication between a non-illustrated vehicle such as a truck and a non-illustrated external server that records a vehicle speed or a rotational speed of an engine, through a non-illustrated network N, regardless of whether the network is wired or wireless. Furthermore, the communication unit 111 receives, and outputs to the control unit 130, an instruction that is input to a non-illustrated terminal or the like of an operator, and transmits the processing result that is output from the control unit 130 to such a terminal or the like of an operator.

The input/output unit 112 displays information that is output from the control unit 130 on a non-illustrated display device. Furthermore, the input/output unit 112 accepts, and outputs to the control unit 130, an operation by a non-illustrated operator.

The storage unit 120 stores, for example, a program that is executed by the control unit 130, a variety of data, and the like. Furthermore, the storage unit 120 includes a vehicle DB 121 and a determination result DB 122. The storage unit 120 corresponds to a semiconductor memory element such as a Random Access Memory (RAM), a Read Only Memory (ROM), or a flash memory, or a storage device such as a Hard Disk Drive (HDD).

The vehicle DB 121 associatively stores information such as a specification of a vehicle that is a target for determination and a threshold that is applied to such a vehicle. FIG. 4 is a diagram illustrating an example of a vehicle DB in the first embodiment. As illustrated in FIG. 4, the vehicle DB 121 associates with a “vehicle ID”, and stores, a “vehicle weight”, a “loading capacity”, a “torque”, a “time threshold”, and a “rotational speed threshold”. Additionally, information that is stored in the vehicle DB 121 is preliminarily input by, for example, a user, a manager, or the like of the loaded/unloaded state determination device 100.

in FIG. 4, a “vehicle ID” is an identifier that uniquely identifies a vehicle that is held by, for example, a business operator. A “vehicle weight”, a “loading capacity”, and a “torque” store a specification of a vehicle that corresponds to a vehicle ID. A “time threshold” stores a threshold for an acceleration time that is applied to such a vehicle ID. A “rotational speed threshold” stores a threshold for a rotational speed of an engine that is applied to such a vehicle ID.

As illustrated in FIG. 4, the vehicle DB 121 stores, for example, a vehicle weight of a vehicle with a vehicle ID of “A001” being “8,000 kg”, a loading capacity being “14,000 kg”, and a torque being “1,800 N·m”. Furthermore, the vehicle DB 121 stores a time threshold of “5.0 seconds” and a rotational speed of an engine threshold of “2,500 rpm” being applied to a vehicle with a vehicle ID of “A001”.

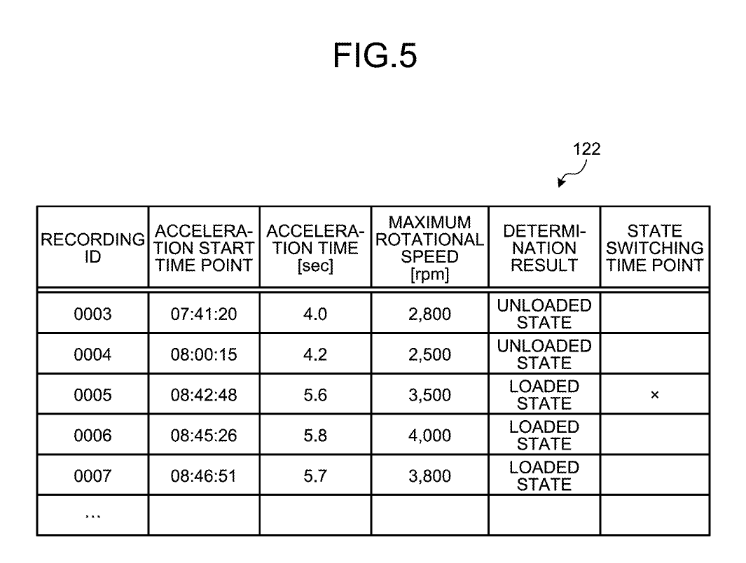

By returning to FIG. 3, the determination result DB 122 stores a progress and a determination result of a loaded/unloaded state determination process of a vehicle. FIG. 5 is a diagram illustrating an example of a determination result DB in the first embodiment. As illustrated in FIG. 5, the determination result DB 122 associates with a “recording ID”, and stores, an “acceleration start time point”, an “acceleration time”, a “maximum rotational speed”, a “determination result”, and a “state switching time point”. The determination result DB 122 includes, for example, one table for one vehicle ID. Additionally, information that is stored in the determination result DB 122 is input by, for example, a vehicle speed acquisition unit 131, a rotational speed acquisition unit 132, or a determination unit 133 as described later.

in FIG. 5, a “recording ID” is information that uniquely identifies a progress and a determination result of a loaded unloaded state determination process of a vehicle. An “acceleration start time point” stores a point of time when a vehicle that is in a static state starts to accelerate. An “acceleration time” stores an acceleration time of a vehicle that is acquired for acceleration at an acceleration stat time point. A “maximum rotational speed” stores a maximum value of a rotational speed of an engine of a vehicle in an acceleration time. A “determination result” stores a result provided by determining whether a vehicle is loaded or not. Additionally, hereinafter, a “static state” includes a state where running is executed at a vehicle speed that is regarded as static.

A “state switching time point” stores information regarding a point of time when it is determined that a vehicle is switched from a loaded state to an unloaded state or a point of time when it is determined that a vehicle is switched from an unloaded state to a loaded state. Additionally, hereinafter, a vehicle switching from a loaded state to an unloaded state and a vehicle switching from an unloaded state to a loaded state may collectively be represented by “state switching”. The determination result DB 122 in the present embodiment stores “X” if state switching is determined to occur.

For example, in FIG. 5, the determination result DB 122 stores a vehicle starting to accelerate at “07:41:20” and reaching a predetermined vehicle speed after “4.0” seconds, and a maximum rotational speed during acceleration being “2,800” rpm, as a processing result for a recording ID of “0003”. Furthermore, the determination result DB 122 stores such a vehicle being determined to be in an “unloaded” state at an acceleration start time point and state switching being determined not to occur.

Furthermore, in FIG. 5, the determination result DB 122 stores that a vehicle started to accelerate at “8:42:48” and reached a predetermined vehicle speed after “5.6” seconds, and that a maximum rotational speed of an engine during acceleration was “3,500” rpm, as a processing result for a recording ID of “0005”. Furthermore, the determination result DB 122 stores such a vehicle being determined to be loaded state at an acceleration start time point and state switching being determined to occur.

By returning to FIG. 3, the control unit 130 is a processing unit that controls a whole process of the loaded/unloaded state determination device 100, or for example, is a processor or the like. The control unit 130 includes a vehicle speed acquisition unit 131, a rotational speed acquisition unit 132, and a determination unit 133. Additionally, the vehicle speed acquisition unit 131, the rotational speed acquisition unit 132, and the determination unit 133 are examples of an electronic circuit that is included in a processor or examples of a process that is executed by such a processor.

The vehicle speed acquisition unit 131 acquires information regarding a vehicle speed. For example, the vehicle speed acquisition unit 131 acquires, and stores in the storage unit 120, a vehicle speed of a non-illustrated vehicle in units of 0.1 second. Although the vehicle speed acquisition unit 131 receives a vehicle speed from a vehicle in real time, for example, through the communication unit 111, this process does not limit the means of acquiring the speed. For example, the vehicle speed acquisition unit 131 may collectively acquire information of a vehicle speed that is stored in a non-illustrated database of a vehicle or an external database with a period of an hour, a day, or the like.

Furthermore, the vehicle speed acquisition unit 131 determines whether or not an acquired vehicle speed is greater than or equal to a predetermined vehicle speed. Moreover, if it is determined to be greater than or equal to a predetermined threshold, the vehicle speed acquisition unit 131 calculates an acceleration time until a vehicle reaches such a vehicle speed from starting to accelerate, and stores the acceleration time in the determination result DB 122 by associating it with a recording ID. Furthermore, the vehicle speed acquisition unit 131 also stores an acceleration start time point that indicates a time when a vehicle starts to accelerate in the determination result DB 122, by associating the acceleration start time point with a recording ID.

The rotational speed acquisition unit 132 acquires information regarding a rotational speed of an engine of a vehicle. For example, the rotational speed acquisition unit 132 acquires a rotational speed of an engine of a non-illustrated vehicle in units of 0.1 second, and stores the rotational speed in the storage unit 120. Although the rotational speed acquisition unit 132 receives a rotational speed of an engine from a vehicle in real time in this case, for example, through the communication unit 111, this does not limit the means of acquiring the rotational speed. For example, the rotational speed acquisition unit 132 may collectively acquire information regarding a rotational speed of an engine that is stored in a non-illustrated database of a vehicle or an external database, with a period of an hour, a day, or the like.

Furthermore, the rotational speed acquisition unit 132 determines whether or not an acceleration time is associated with a corresponding vehicle ID and stored in the determination result DB 122. If an acceleration time is determined to be stored, the rotational speed acquisition unit 132 stores a maximum rotational speed among the rotational speed of an engine that corresponds to an acceleration time in the determination result DB 122, by associating the maximum rotational speed with a recording ID.

The determination unit 133 determines whether a vehicle is loaded or not by using an acceleration time and a rotational speed of an engine. Specifically, the determination unit 133 determines whether or not an acceleration time that is stored in the determination result DB 122 is greater than or equal to a time threshold that is stored in the vehicle DB 121 in association with a corresponding vehicle ID. If an acceleration time is determined to be greater than or equal to a time threshold, the determination unit 133 stores such a vehicle as loaded state in the determination result DB 122 in association With a corresponding recording ID.

Furthermore, if a stored acceleration time is determined to be less than a time threshold, the determination unit 133 determines whether or not a rotational speed of an engine that is stored in the determination result DB 122 is greater than or equal to a rotational speed threshold that is stored in the vehicle DB 121 in association with a corresponding vehicle ID. If a stored rotational speed is determined to be greater than or equal to a rotational speed threshold, the determination unit 133 stores such a vehicle as loaded in the determination result DB 122 in association with a corresponding recording ID. On the other hand, if a stored acceleration time is determined to be less than a time threshold and a stored rotational speed of an engine is determined to be less than a rotational speed threshold, the determination unit 133 stores such a vehicle as unloaded in the determination result DB 122 in association with a corresponding recording ID.

Moreover, the determination unit 133 compares a determination result with a loaded state or an unloaded state that is stored in association with a last corresponding recording ID. If a determination result is not consistent with a loaded state or an unloaded state that is stored associated with a corresponding last recording ID, or if state switching is determined to occur, the determination unit 133 stores “X” in the determination result DB 122 as information that indicates such state switching occurred.

Flow of Process

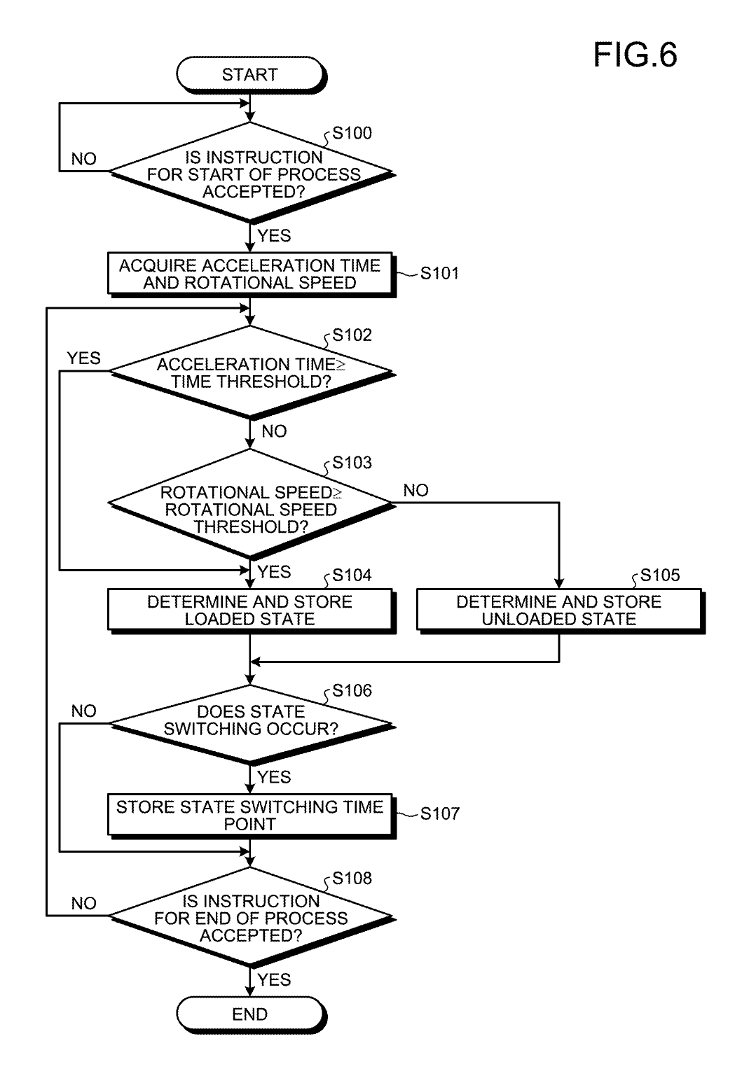

Next, a loaded/unloaded state determination process to be executed by the loaded/unloaded state determination device 100 in the present embodiment will be described. FIG. 6 is a flowchart illustrating an example of a loaded/unloaded state determination process in the first embodiment.

As illustrated in FIG. 6, the vehicle speed acquisition unit 131 of the loaded/unloaded state determination device 100 waits, for example, until an instruction for a start of a process is accepted from a non-illustrated terminal of a user (S100: No). As an instruction for a start of a process is accepted (S100: Yes), the vehicle speed acquisition unit 131 stores, in the determination result DB 122, an acceleration time that is calculated based on data of a speed of a target vehicle. Furthermore, the rotational speed acquisition unit 132 acquires data of a rotational speed of an engine of a target vehicle (S101), and stores the acquired data in the determination result DB 122.

Then, the determination unit 133 determines whether or not an acceleration time that is stored in the determination result DB 122 is greater than or equal to a time threshold (S102). If an acceleration time is determined to be greater than or equal to a time threshold (S102: Yes), the determination unit 133 determines that a vehicle is loaded and stores a processing result in the determination result DB 122 (S104). Afterward, the determination unit 133 transfers to S106.

if an acceleration time is determined to be less than a time threshold (S102: No), the determination unit 133 determines whether or not a rotational speed of an engine that is stored in the determination result DB 122 is greater than or equal to a rotational speed threshold (S103). If a rotational speed of an engine is determined to be greater than or equal to a rotational speed threshold (S103: Yes), the determination unit 133 determines that a vehicle is loaded and stores a processing result in the determination result DB 122 (S104). Afterward, the determination unit 133 transfers to S106.

If a rotational speed of an engine is determined to be less than a rotational speed threshold (S103: No), the determination unit 133 determines that a vehicle is unloaded and stores the processing result in the determination result DB 122 (S105). Afterward, the determination unit 133 transfers to S106.

Then, the determination unit 133 determines whether or not state switching occurs (S106). If state switching is determined to occur (S106: Yes), the determination unit 133 stores a state switching time point in the determination result DB 122 (S107) and transfers to S108. If state switching is determined not to occur (S106: No), the determination unit 133 transfers to S108.

Then, the determination unit 133 determines, for example, whether or not an instruction for an end of a process is accepted from a non-illustrated terminal of a user (S108). If an instruction for an end of a process is determined not to be accepted (S108 No), the determination unit 133 returns to S102 and repeats such a process. On the other hand, if an instruction for an end of a process is determined to be accepted (S108: Yes), the determination unit 133 ends such a process.

Effect

As described above, a loaded/unloaded state determination program in the present embodiment causes a computer to execute a process that acquires a period of time until a vehicle reaches a predetermined vehicle speed and determines that a cargo is loaded on such a vehicle if such an acquired period of time satisfies a predetermined condition. Thereby, it is possible to determine a loaded state or unloaded state of a vehicle without depending on positional information, an operation of a driver, a device such as a vehicle mass measurement means, or a loaded/unloaded state switch to a vehicle, as the background technique mentioned above exemplified. Furthermore, it is possible to accurately determine what point of time a loaded state or unloaded state is changed at, that is, when cargo loading or unloading is executed.

Furthermore, a loaded/unloaded state determination program in the present embodiment causes a computer to execute a process that compares a period of time until a vehicle reaches a predetermined vehicle speed from a static state with a first threshold and determines that a predetermined condition is satisfied if such a period of time is greater than or equal to such a first threshold. Thereby, it is possible to determine a loaded state or unloaded state of a vehicle based on a simple configuration without acquiring a rotational speed of an engine, a vehicle mass, or the like.

Moreover, a loaded/unloaded state determination program in the present embodiment causes a computer to execute a process that determines whether or not a rotational speed of an engine within a period of time until a vehicle reaches a predetermined vehicle speed from a static state is greater than or equal to a second threshold if such a period of time is less than a first threshold. Furthermore, a loaded/unloaded state determination program in the present embodiment causes a computer to execute a process that determines that a predetermined condition is satisfied if a rotational speed of an engine is determined to be greater than or equal to a second threshold. Thereby, it is possible to accurately determine a loaded state or unloaded state of a vehicle even if a vehicle accelerates suddenly.

Additionally, a loaded/unloaded state determination program in the present embodiment may cause a computer to execute a process that determines whether or not a predetermined condition is satisfied, by using only a rotational speed of an engine, without acquiring a period of time until a vehicle reaches a predetermined vehicle speed from a static state.

[b] Second Embodiment

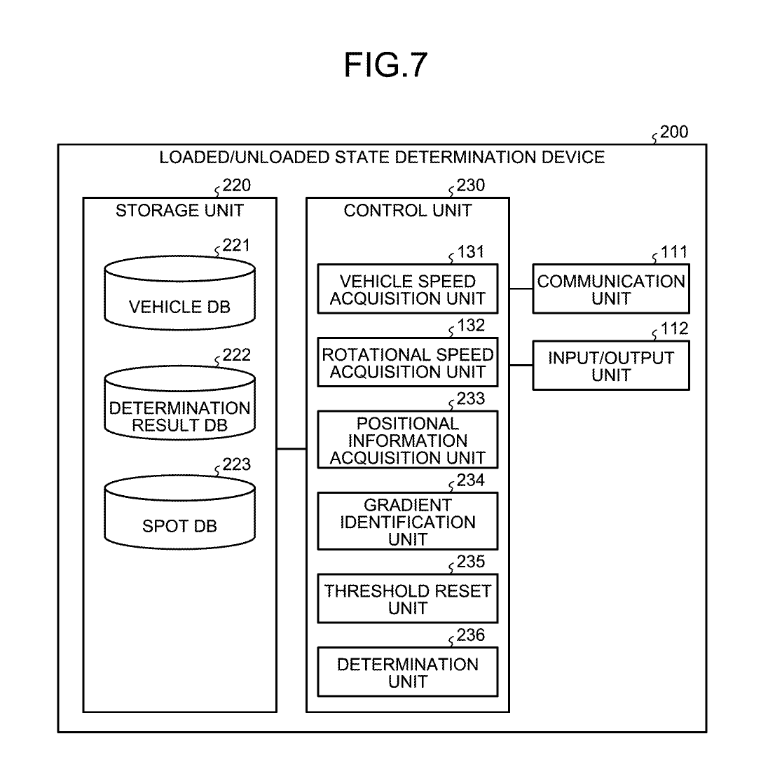

Although it is possible for the loaded/unloaded state determination device 100 in the first embodiment to determine a loaded state or unloaded state of a vehicle without using positional information, embodiments are not limited thereto. For example, in a second embodiment, a loaded/unloaded state determination device 200 that determines a loaded state or unloaded state of a vehicle by further using positional information will be described by using FIG. 7 to FIG. 11.

For example, for a large truck for a long distance transportation or the like, a cargo loading or unloading happens in a predetermined warehouse, factory, port, or the like. Accordingly, the loaded/unloaded state determination device 200 may be configured to determine a loaded state or unloaded state of a vehicle only if acquired positional information satisfies a predetermined condition.

Additionally, although it is possible to acquire positional information by using, for example, a publicly known Global Positioning System (GPS) receiver or the like, a method for acquiring positional information is not limited thereto. For example, the loaded/unloaded state determination device 200 may acquire positional information by using data such as a Digital Road Map (DRM) that includes information of a height difference or the like of a road.

For example, a load on a vehicle is increased if a vehicle accelerates on an upgrade, whereas the load is decreased if acceleration is executed on a downgrade. Accordingly, the loaded/unloaded state determination device 200 may be configured to change a threshold that is used for determining a loaded state or unloaded state of a vehicle, depending on a height difference of a road.

Functional Blocks

A functional configuration in the present embodiment will be described. FIG. 7 is a diagram illustrating an example of functional blocks of a loaded/unloaded state determination device in the second embodiment. As illustrated in FIG. 7, a loaded/unloaded state determination device 200 in the present embodiment includes a communication unit 111, an input/output unit 112, a storage unit 220 and a control unit 230. Additionally, the loaded/unloaded state determination device 200 is realized by an instrument such as a computer and may include a variety of functional units that are included in a known computer, for example, functional units such as a variety of input devices or audio output devices, as well as functional units as illustrated in FIG. 7. Furthermore, in the following embodiment, a part identical to a part illustrated in the drawings as described previously will be provided with an identical symbol to omit a redundant description thereof.

The storage unit 220 stores, for example, a program that is executed by the control unit 230, a variety of data, and the like. Furthermore, the storage unit 220 includes a vehicle DB 221, a determination result DB 222, and a spot DB 223. The storage unit 220 corresponds to a semiconductor memory element such as a RAM, a ROM, or a flash memory or a storage device such as an HDD.

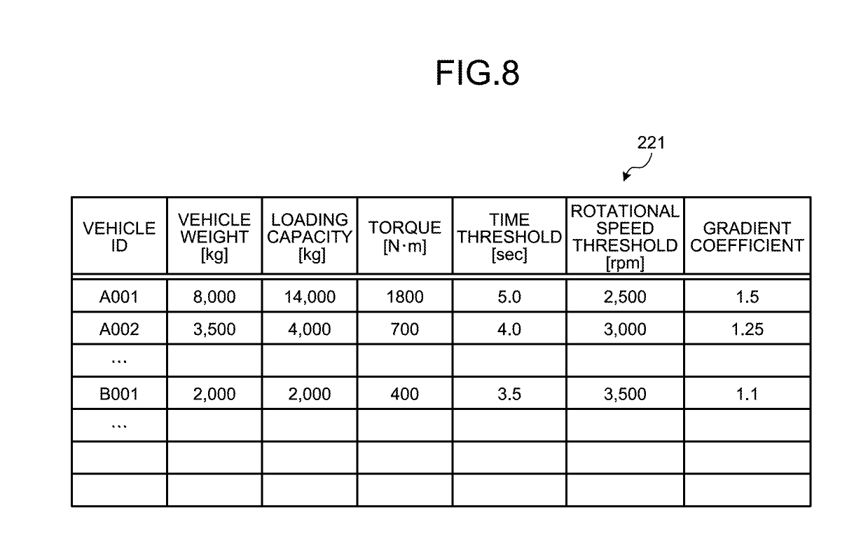

The vehicle DB 221 in the present embodiment associatively stores a “gradient coefficient” that is information for changing a threshold depending on a gradient, as illustrated in FIG. 8, in addition to information that is stored in the vehicle DB 121 in the first embodiment. FIG. 8 is a diagram illustrating an example of a vehicle DB in the second embodiment. Additionally, the vehicle DB 221 also stores, for example, information that is preliminarily input by a user, a manager, or the like of the loaded/unloaded state determination device 200, similarly to the vehicle DB 121.

In FIG. 8, a “gradient coefficient” is used to change a “time threshold” and a “rotational speed threshold” depending on a gradient of a road after an acceleration start time point and before a point of time when reaching a predetermined vehicle speed. A “gradient coefficient” is also set individually for each vehicle ID, similarly to a “time threshold” and a “rotational speed threshold”.

For example, in a loaded/unloaded state determination process in the present embodiment, a threshold that is reset according to a formula (1) as indicated below is used.

Threshold to be reset=(Time threshold×Gradient×Gradient coefficient) (1)

For example, if a vehicle with a vehicle ID of “A001” starts to accelerate on a road with a gradient of “5%”, a time threshold that is used for a loaded/unloaded state determination process is changed to “5.0 seconds+(5.0 seconds×5%×1.5)”=5.375 seconds according to formula (1).

Additionally, in a loaded/unloaded state determination process in the present embodiment, a threshold that is reset according to formula (2) as indicated below is similarly used for a rotational speed threshold.

Threshold to be reset=(a rotational speed threshold×Gradient×Gradient coefficient) (2)

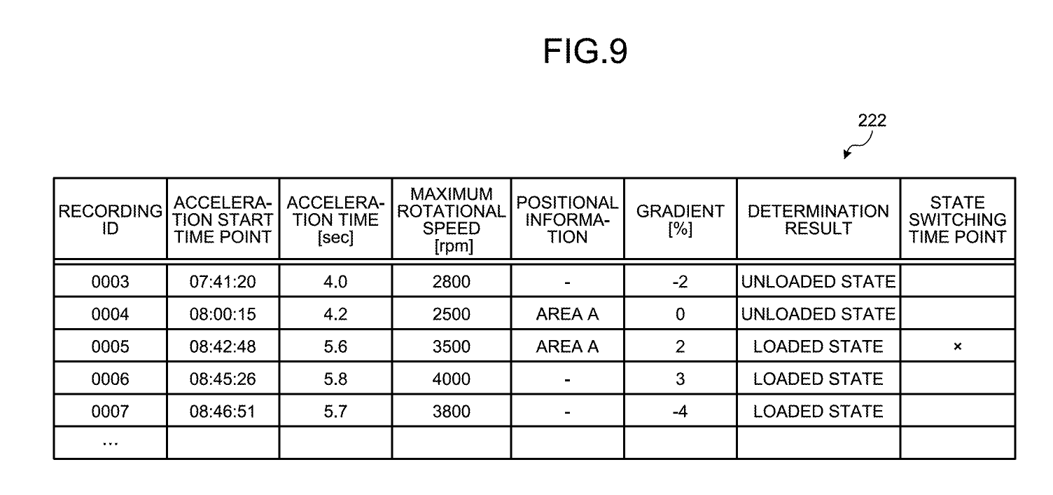

By returning to FIG. 7, the determination result DB 222 in the present embodiment stores “positional information” and a “gradient” as illustrated in FIG. 9 in addition to items that are stored in the determination result DB 122 in the first embodiment, as a progress and a determination result of a loaded/unloaded state determination process of a vehicle. FIG. 9 is a diagram illustrating an example of a determination result DB in the second embodiment. Additionally, information that is stored in the determination result DB 222 is input by, for example, a vehicle speed acquisition unit 131, a rotational speed acquisition unit 132, a positional information acquisition unit 233, a gradient identification unit 234, and a determination unit 236 as described later.

in FIG, 9, “positional information” stores information regarding whether or not a vehicle is present at a particular position as described later. Furthermore, a “gradient” stores a gradient of a road at an interval until a vehicle reaches a predetermined vehicle speed from the point where the vehicle started to acceleration.

For example, as illustrated in FIG. 9, the determination result DB 222 further stores a state that a vehicle is not in a particular position, and that a gradient of a road is “−2%”, as a processing result for a recording ID of “0003”. Furthermore, the determination result DB 222 further stores the state that a vehicle is in a predetermined position of “area A”, and that a gradient of a road is “2%”, as a processing result for a recording ID of “0005”.

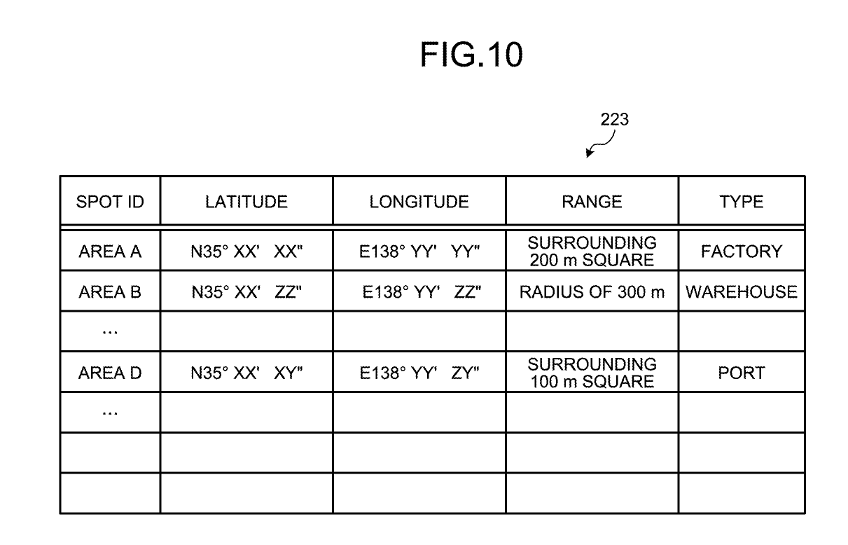

By returning to FIG. 7, the spot DB 223 in the present embodiment stores information regarding a spot where there is a high possibility that a cargo loading or unloading happens thereon. FIG. 10 is a diagram illustrating an example of a spot DB in the second embodiment. As illustrated in FIG. 10, the spot DB 223 stores a “latitude”, a “longitude”, a “range”, and a “type” in association with a “spot ID”.

In FIG. 10, a “spot ID” stores information that uniquely identifies a particular spot. A “latitude” and a “longitude” store a position of a spot. A “type” stores a type of a facility at a predetermined spot such as a warehouse, a factory, or a port. Furthermore, a “range” stores a size of a range that is included in a spot. Additionally, a “range” may include a parking space, a road, or the like around a facility in addition to a facility, per se, such as a warehouse, a factory, or a port.

For example, the spot DB 223 as illustrated in FIG. 10 stores a spot with a spot ID of “area A” being a “factory” centered on a north latitude of “35° XX′ XX″” and an east longitude of “138° YY′ YY″” including its range of “surrounding 200 m square”.

By returning to FIG. 7, the control unit 230 is a processing unit that controls a whole process of the loaded/unloaded state determination device 200, and is, for example, a processor or the like. The control unit 230 includes a vehicle speed acquisition unit 131, a rotational speed acquisition unit 132, a positional information acquisition unit 233, a gradient identification unit 234, a threshold reset unit 235, and a determination unit 236. Additionally, the vehicle speed acquisition unit 131, the rotational speed acquisition unit 132, the positional information acquisition unit 233, the gradient identification unit 234, the threshold reset unit 235, and the determination unit 236 are examples of an electronic circuit that is included in a processor or examples of a process that is executed by such a processor.

The positional information acquisition unit 233 acquires positional information of a vehicle. The positional information acquisition unit 233 acquires, through the communication unit 111, and stores in the determination result DB 222, positional information that is acquired by a GPR receiver or the like that is mounted on a non-illustrated vehicle, for example, at a predetermined interval such as 1 second.

The gradient identification unit 234 identifies a gradient of a road. For example, if a static vehicle starts to accelerate, the gradient identification unit 234 identifies positional information of such a static vehicle and positional information at a point of time when such a vehicle reaches a predetermined vehicle speed. Furthermore, the gradient identification unit 234 acquires digital road map information from a non-illustrated DRM database through the communication unit 111 and acquires an altitude that corresponds to each piece of acquired positional information. The gradient identification unit 234 calculates a height difference of an altitude at a position that corresponds to each piece of acquired position information and calculates a gradient of a road based on such a height difference and a distance between respective positions. Then, the gradient identification unit 234 stores a calculated gradient of a road in the determination result DB 222.

The threshold reset unit 235 resets a time threshold and a rotational speed threshold by using information regarding a gradient. For example, the threshold reset unit 235 acquires a time threshold and a gradient coefficient from the vehicle DB 221, acquires a gradient from the determination result DB 222, and rests a threshold by using formula (1). Furthermore, the threshold reset unit 23 acquires a rotational speed threshold and a gradient coefficient from the vehicle DB 221, acquires a gradient from the determination result DB 222, and resets a threshold by using formula (2).

The determination unit 236 in the present embodiment determines whether or not positional information of a vehicle that is acquired by the positional information acquisition unit 233 corresponds to a predetermined spot that is stored in the spot DB 223. If positional information of a vehicle is determined to correspond to a predetermined spot, the determination unit 236 determines whether a vehicle is loaded or not, by using an acceleration time and a rotational speed of an engine.

Furthermore, for a threshold, the determination unit 236 uses a threshold that is reset by the threshold reset unit 235, instead of a time threshold and a rotational speed threshold that are stored in the vehicle DB 221.

Flow of Process

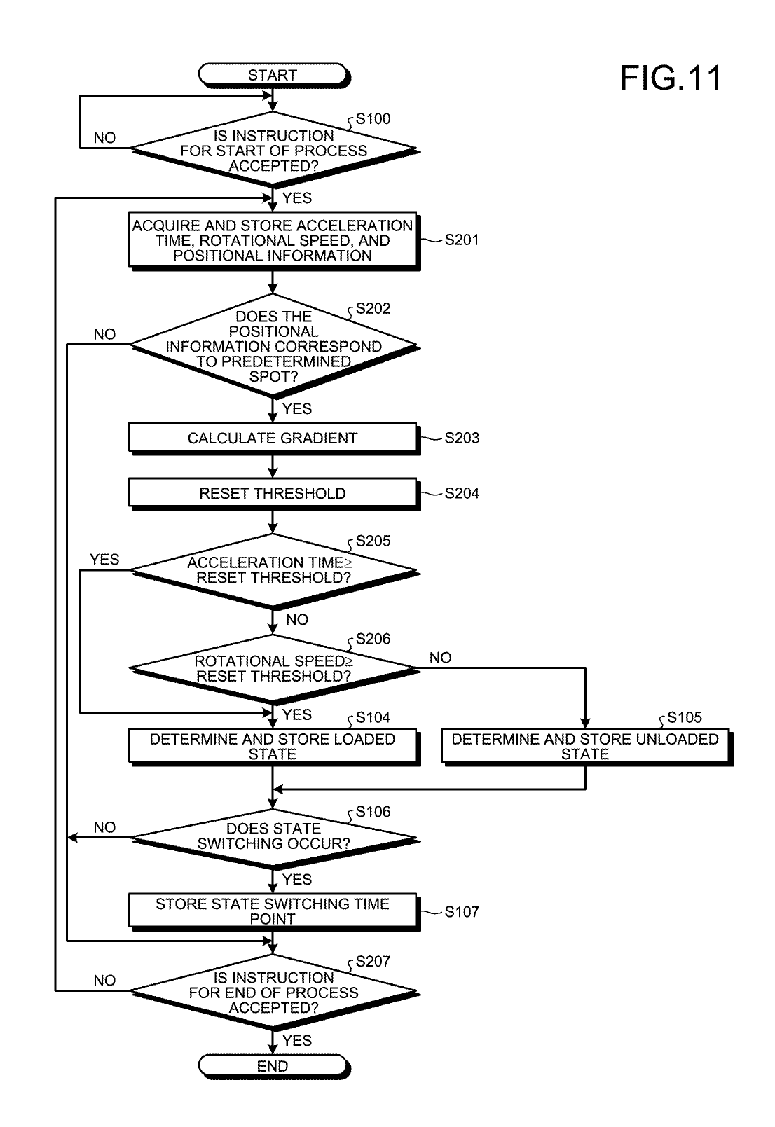

Next, a loaded/unloaded state determination process to be executed by the loaded/unloaded state determination device 200 in the present embodiment will be described. FIG. 11 is a flowchart illustrating an example of a loaded/unloaded state determination process in the second embodiment. First, as an instruction for a start of a process is accepted (S100: Yes), the vehicle speed acquisition unit 131 of the loaded/unloaded state determination device 200 stores, in the determination result DB 222, an acceleration time that is calculated based on data of a speed of a target vehicle. Furthermore, the rotational speed acquisition unit 132 acquires data of a rotational speed of an engine of a target vehicle, and stores the acquired data in the determination result DB 222. Moreover, the positional information acquisition unit 233 acquires positional information until a vehicle reaches a predetermined vehicle speed from starting to accelerate (S201), and stores the positional information in the determination result DB 222.

Then, the determination unit 236 determines whether or not positional information that is stored in the determination result DB 222 corresponds to a predetermined spot (S202). If the positional information is determined not to correspond to a predetermined spot (S202: No), the determination unit 236 transfers to S207.

On the other hand, if the positional information is determined to correspond to a predetermined spot (S202: Yes), the gradient identification unit 234 calculates a gradient, and stores the calculated gradient in the determination result DB 222 (S203). Then, the threshold reset unit 235 acquires a time threshold and a rotational speed threshold that are stored in the vehicle DB 221 and a gradient that is stored in the determination result DB 222, and resets a threshold (S204).

Then, the determination unit 236 determines whether or not an acceleration time that is stored in the determination result DB 222 is greater than or equal to a reset threshold (S205). If an acceleration time is determined to be greater than or equal to a reset threshold (S205: Yes), the determination unit 236 determines that a vehicle is loaded and stores the processing result in the determination result DB 222 (S104). Afterward, the determination unit 236 transfers to S106.

On the other hand, if an acceleration time is determined to be less than a reset threshold (S205: No), the determination unit 236 determines whether or not a rotational speed of an engine that is stored in the determination result DB 222 is greater than or equal to a reset threshold (S206). If a rotational speed of an engine is determined to be greater than or equal to a reset threshold (S206: Yes), the determination unit 236 determines that a vehicle is loaded and stores the processing result in the determination result DB 222 (S104). Afterward, the determination unit 236 transfers to S106.

if a rotational speed of an engine is determined to be less than a reset threshold (S206: No), the determination unit 236 determines that a vehicle is unloaded and stores a processing result in the determination result DB 222 (S105). Afterward, the determination unit 236 transfers to S106.

Then, the determination unit 236 determines whether or not state switching occurs (S106). If state switching is determined to occur (S106: Yes), the determination unit 236 stores a state switching time point in the determination result DB 222 (S107) and transfers to S207. If state switching is determined not to occur (S106: No), the determination unit 236 transfers to S207.

Then, the determination unit 236 determines, for example, whether or not an instruction for an end of a process is accepted from a non-illustrated terminal of a user (S207). If an instruction for an end of a process is determined not to be accepted (S207: No), the determination unit 236 returns to S201 to repeat such a process. On the other hand, if an instruction for an end of a process is determined to be accepted (S207: Yes), the determination unit 236 ends such a process.

Effect

A loaded/unloaded state determination program in the present embodiment identifies a gradient of a distance from a position where a vehicle is static to a predetermined spot where a vehicle passes there through, and changes a first threshold or a second threshold based on such an identified gradient. Thereby, it is possible to change a threshold depending on a gradient of a road or the like, and hence, it is possible to reduce erroneous determination of a loaded state or unloaded state of a vehicle.

Furthermore, the loaded/unloaded state determination device 200 in the present embodiment does not execute a process for determination of a loaded state or unloaded state of a vehicle if the positional information does not correspond to a predetermined position, and hence, it is possible to reduce a processing load. Additionally, the loaded/unloaded state determination device 200 may be configured to change a threshold that is used for determining a loaded state or unloaded state of a vehicle, depending on whether acquired positional information satisfies a predetermined condition or not, by using, for example, a coefficient similar to a gradient coefficient. For example, a loaded/unloaded state determination device decreases a threshold that is used for determining a loaded state or unloaded state of a vehicle, at a spot where there is a high possibility that cargo loading or unloading happens, or uses a higher threshold at other spots. It is possible for the loaded/unloaded state determination device 200 that has such a configuration to reduce erroneous determination of a loaded state or unloaded state of a vehicle.

[c] Third Embodiment

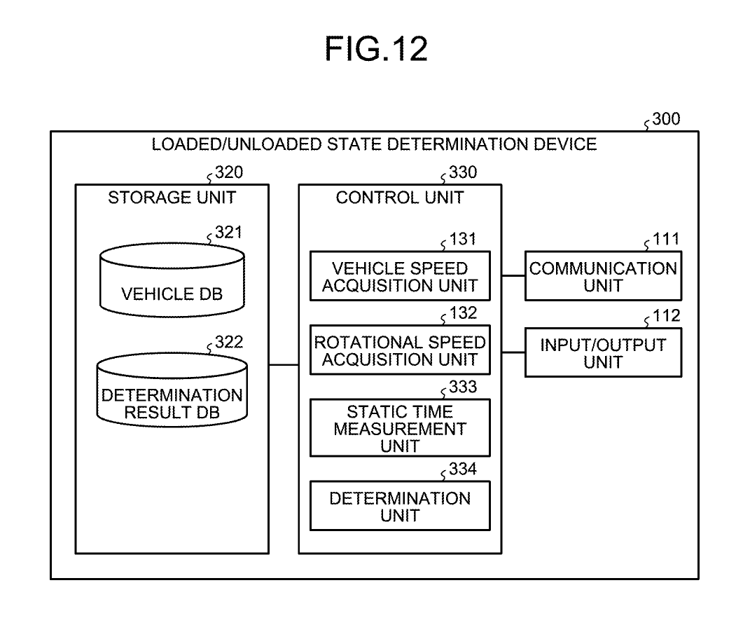

Although a configuration to determine a loaded state or unloaded state of a vehicle by using an acceleration time and a rotational speed of an engine has been described in each of the above-mentioned embodiments, embodiments are not limited thereto. For example, for a large truck for long distance transportation or the like, cargo loading or unloading does not happen so frequently, and loading or unloading for such a vehicle takes more time than it does for shorter distance transportation. Moreover, if cargo loading or unloading does not occur, an acceleration time or a rotational speed of an engine is not changed significantly. Accordingly, in a third embodiment, a configuration of a loaded/unloaded state determination device 300 to determine a loaded state or unloaded state of a vehicle based on a length of a static time and a difference of an acceleration time or a rotational speed of an engine between before and after such a static time will be described by using FIG. 12 to FIG. 15.

Functional Blocks

A functional configuration in the present embodiment will be described. FIG. 12 is a diagram illustrating an example of functional blocks of a loaded/unloaded state determination device in the third embodiment. As illustrated in FIG. 12, a loaded/unloaded state determination device 300 in the present embodiment includes a communication unit 111, an input/output unit 112, a storage unit 320, and a control unit 330. Additionally, the loaded/unloaded state determination device 300 is realized by an instrument such as a computer and may include a variety of functional units that are included in a known computer, for example, functional units such as a variety of input devices or audio output devices, as well as functional units as illustrated in FIG. 12. Furthermore, in the following embodiment, a part identical to a part as illustrated in the drawings as described previously will be provided with an identical symbol to omit a redundant description thereof.

The storage unit 320 stores, for example, a program that is executed by the control unit 330, a variety of data, and the like. Furthermore, the storage unit 320 includes a vehicle DB 321 and a determination result DB 322. The storage unit 320 corresponds to a semiconductor memory element such as a RAM, a ROM, or a flash memory, or a storage device such as an HDD.

The vehicle DB 321 in the present embodiment stores, a “static time threshold”, a “time difference threshold”, and a “rotational speed difference threshold” in addition to a “vehicle weight”, a “loading capacity”, and a “torque” in association with a “vehicle ID”. Additionally, information that is stored in the vehicle DB 321 is preliminarily input by, for example, a user, a manager, or the like of the loaded/unloaded state determination device 300.

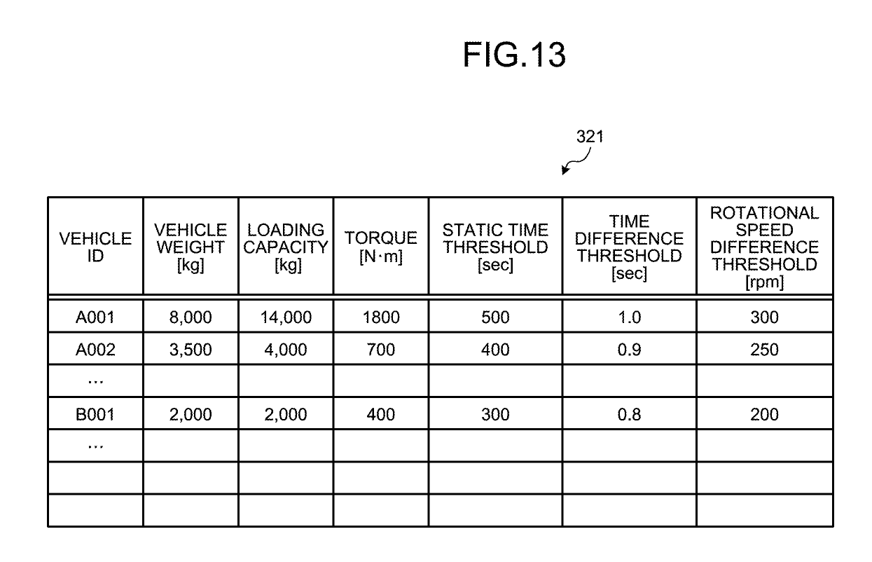

FIG. 13 is a diagram illustrating an example of a vehicle DB in the third embodiment. In FIG. 13, a “static time threshold” stores a threshold for a static time as described later that is applied to such a vehicle ID. A “time difference threshold” stores a threshold for a difference of an acceleration time as described later that is applied to such a vehicle ID. A “rotational speed difference threshold” stores a threshold for a difference of a rotational speed time as described later that is applied to such a vehicle ID. Additionally, a static time threshold is an example of a third threshold and a time difference threshold is an example of a fourth threshold. Furthermore, a rotational speed difference threshold is an example of a fifth threshold.

As illustrated in FIG. 13, the vehicle DB 321 in the third embodiment stores a static time threshold of “500 seconds”, a time difference threshold of “1.0 second”, and a rotational speed difference threshold of “300 rpm” that correspond to a vehicle with a vehicle ID of “A001”.

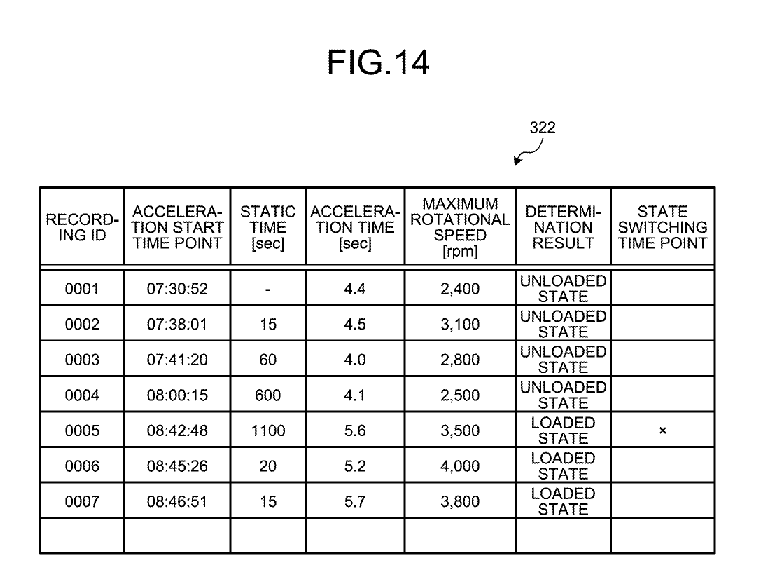

By returning to FIG. 12, the determination result DB 322 in the present embodiment further stores a “static time” of a vehicle in addition to items that are stored in the determination result DB 122 in the first embodiment. FIG. 14 is a diagram illustrating an example of a determination result DB in the third embodiment. Additionally, information that is stored in the determination result DB 322 is input by, for example, a static time measurement unit 333 and a determination unit 334 as described later.

In FIG. 14, a “static time” stores a period of time when a vehicle is static until the vehicle starts to accelerate. Additionally, a static time is an example of a period of time when a vehicle is static after a point of time when the vehicle is stopped and before a point of time when the vehicle starts to move.

For example, as illustrated in FIG. 14, the determination result DB 322 further stores a vehicle staring to accelerate after being static for “60” seconds, as a processing result for a recording ID of “0003”. Furthermore, the determination result DB 322 further stores a vehicle starting to accelerate after being static for “1100” seconds, as a processing result for a recording ID of “0005”.

By returning to FIG. 12, the control unit 330 is a processing unit that controls a whole process of the loaded/unloaded state determination device 300, and is, for example, a processor or the like. The control unit 330 includes a vehicle speed acquisition unit 131, a rotational speed acquisition unit 132, a static time measurement unit 333, and a determination unit 334. Additionally, the vehicle speed acquisition unit 131, the rotational speed acquisition unit 132, the static time measurement unit 333, and the determination unit 334 are examples of an electronic circuit that is included in a processor or examples of a process that is executed by such a processor.

The static time measurement unit 333 measures a period of time after a vehicle is stopped and before the vehicle starts to accelerate. For example, the static time measurement unit 333 determines whether or not a last vehicle speed that is stored in the storage unit 320 is “0 km/h”. If a stored last vehicle speed is determined to be “0 km/h”, the static time measurement unit 333 activates a timer and measures a period of time until a vehicle speed exceeds “0 km/h” is stored in the storage unit 320. The static time measurement unit 333 stores a point of time when a vehicle speed exceeds “0 km/h” is stored in the storage unit 320, as an acceleration start time point, in the determination result DB 322. Furthermore, the static time measurement unit 333 stores a period of time, measured by a timer, after a vehicle speed becomes “0 km/h” and before acceleration starts as a static time, in the determination result DB 322.

The determination unit 334 in the present embodiment determines whether or not a static time is greater than or equal to a predetermined static time threshold, with reference to the determination result DB 322. For example, if a static time that is stored in the determination result DB 322 is determined to be greater than or equal to a predetermined static time threshold, the determination unit 334 determines whether or not a difference between an acceleration time before a static time and an acceleration time on or after such a static time is greater than or equal to a predetermined time difference threshold. Then, if such a difference is determined to be greater than or equal to a time difference threshold, the determination unit 334 determines that state switching occurs in such a static time.

Additionally, the determination unit 334 may be configured to determine whether or not a difference between a rotational speed of an engine before a static time and a rotational speed of an engine on or after such a static time, instead of an acceleration time, is greater than or equal to a predetermined rotational speed difference threshold. Furthermore, a configuration may be provided so as to determine whether or not a difference between an average of a predetermined number of (for example, three) acceleration times before a static time and an average of a predetermined number of acceleration times on or after such a static time is greater than or equal to a predetermined rotational speed difference threshold. Additionally, hereinafter, an average of acceleration times before a static time and an average of acceleration times on or after such a static time may be represented by t0 and t1, respectively. Furthermore, hereinafter, an average of a rotational speed of an engine before a static time and an average of a rotational speed of an engine on or after such a static time may be represented by r0 and r1, respectively.

For example, if a vehicle ID of “A001” is a target for determination, because a recording ID of “0003” as illustrated in FIG. 14 shows that a static time is less than “500 seconds”, the determination unit 334 does not execute a determination process that uses an acceleration time. On the other hand, for a recording ID of “0004” as illustrated in FIG. 14, because a static time is greater than or equal to “500 seconds”, the determination unit 334 executes a determination process that uses an acceleration time.

For example, the determination unit 334 calculates an average t0 of “4.3 seconds” of a predetermined number of acceleration times before a static time for a recording ID of “0004”, that is, respective acceleration times for recording IDs of “0001”, “0002”, and “0003”. Similarly, the determination unit 334 calculates an average t1 of “5.0 seconds” of a predetermined number of acceleration times on or after a static time for a recording ID of “0004”, that is, respective acceleration times for recording IDs of “0004”, “0005”, and “0006”.

Then, since a difference between t1 and t0 is less than “1 second”, the determination unit 334 determines that state switching does not occur at a point of time of a recording ID of “0004”. In such a case, a determination result that corresponds to a recording ID of “0003” just before a recording ID of “0004” is an “unloaded state”, and hence, the determination unit 334 also determines an “unloaded state” for a recording ID of “0004” and stores a determination result in the determination result DB 322.

On the other hand, for a recording ID of “0005” as illustrated in FIG. 14, because a static time is greater than or equal to “500 seconds”, the determination unit 334 executes a determination process that uses an acceleration time. For example, the determination unit 334 calculates an average t0 of “4.2 seconds” of respective acceleration times for recording IDs of “0002”, “0003”, and “0004”. Similarly, the determination unit 334 calculates an average t1 of “5.5 seconds” of respective acceleration times for recording IDs of “0005”, “0006”, and “0007”.

Then, since a difference between t0 and t1 is greater than or equal to “1 second”, the determination unit 334 determines that state switching occurs at a point of time of a recording ID of “0005”. In such a case, a determination result that corresponds to a recording ID of “0004” just before a recording ID of “0005” is an “unloaded state”, so the determination unit 334 determines that a state for a recording ID of “0005” is changed to a “loaded state”, and stores a determination result in the determination result DB 322. Furthermore, the determination unit 334 stores information that indicates that a recording ID corresponds to a “state switching time point” in association with the corresponding recording ID of “0005”.

Additionally, the determination unit 334 may use a difference between r1 and r0. For example, the determination unit 334 executes a determination process that uses a rotational speed of an engine based on a recording ID of “0004” as illustrated in FIG. 14 in which a determination process that uses an acceleration time determines that state switching does not occur, for a vehicle with a vehicle ID of “A001”. The determination unit 334 calculates an average r0 of “2,800 rpm” of respective rotational speed of an engine for recording IDs of “0001”, “0002”, and “0003” and an average r1 of “3,333 rpm” of respective rotational speed of an engine for recording IDs of “0004”, “0005”, and “0006”. Then, since a difference between r0 and r1 is greater than or equal to “500 rpm”, the determination unit 334 determines that state switching occurs at a point of time of a recording ID of “0004”.

Additionally, although a configuration of the loaded/unloaded state determination device 300 to determine a loaded state or unloaded state by using a difference between t0 and t1 or a difference between r0 and r1 has been described without using a threshold, this is not the only example of configuration. For example, the loaded/unloaded state determination device 300 may be configured to store an average of t1 and t0 or an average of r0 and r1 as a time threshold or a rotational speed threshold in the vehicle DB 321, and to use a time threshold or a rotational speed threshold that is stored in a later loaded/unloaded state determination process.

Furthermore, although a configuration to calculate both a set of t0 and t1 and a set of r0 and r1 will be described in the present embodiment, this is not the only example of configuration. For example, as in the case of the first embodiment, the determination unit 334 may be configured to calculate only one of a set of t0 and t1 and a set of r0 and r1 to execute determination of a loaded state or unloaded state. Furthermore, the determination unit 334 may be configured to determine that state switching occurs only if both a difference between t0 and t1 and a difference between r0 and r1 satisfy a condition.

Flow of Process

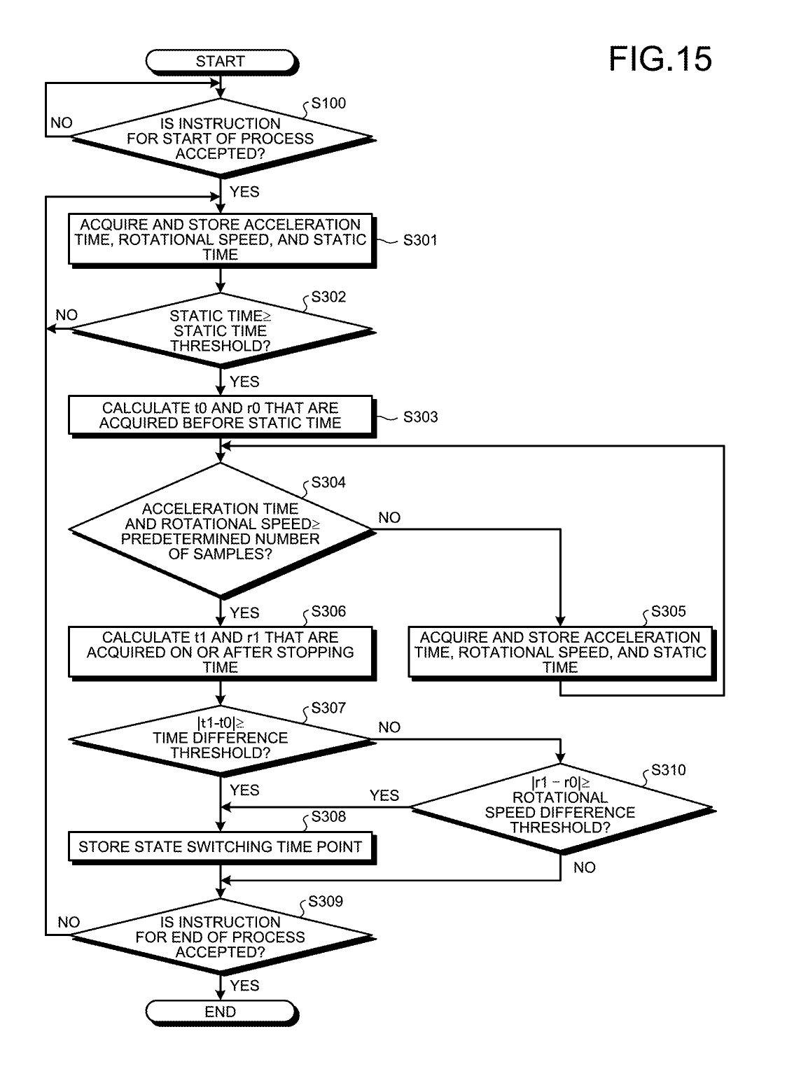

Next, a loaded/unloaded state determination process to be executed by the loaded/unloaded state determination device 300 in the present embodiment will be described. FIG. 15 is a flowchart illustrating an example of a loaded/unloaded state determination process in the third embodiment. First, as an instruction for a start of a process is accepted (S100: Yes), the vehicle speed acquisition unit 131 of the loaded/unloaded state determination device 300 stores an acceleration time that is calculated based on data of a vehicle speed of a target vehicle in the determination result DB 322. Furthermore, the rotational speed acquisition unit 132 acquires data of a rotational speed of an engine of such a target vehicle, and stores the acquired data in the determination result DB 322. Moreover, the static time measurement unit 333 measures a static time (S301) and stores the static time in the determination result DB 322.

Then, the determination unit 334 determines whether or not a static time that is stored in the determination result DB 322 is greater than or equal to a static time threshold that is stored in the vehicle DB 321 (S302). If the static time is determined to be less than a static time threshold (S302: No), the determination unit 334 transfers to S301.

On the other hand, if the static time is determined to be greater than or equal to a static time threshold (S302: Yes), the determination unit 334 calculates an average t0 of acceleration times before a static time and an average r0 of rotational speed of an engine before such a static time (S303).

Then, the determination unit 334 determines whether or not a number of samples of an acceleration time and a rotational speed of an engine that are acquired on or after a static time is greater than or equal to a predetermined number of samples (S304). If static time is determined to be less than a predetermined number of samples (S304: No), the vehicle speed acquisition unit 131 stores an acceleration time that is subsequently calculated based on data of a vehicle speed of a target vehicle in the determination result DB 322. Furthermore, the rotational speed acquisition unit 132 acquires data of a rotational speed of an engine of a target vehicle and stores the acquired data in the determination result DB 322. Moreover, the static time measurement unit 333 measures a static time (S305). Afterward, the determination unit 334 transfers to S304 and stores the static time in the determination result DB 322.

On the other hand, if the static time is determined to be greater than or equal to a predetermined number of samples (S304: Yes), the determination unit 334 calculates an average t1 of acceleration times on or after a static time and an average r1 of rotational speed of an engine on or after such a static time (S306). Then, the determination unit 334 determines whether or not a difference between t1 and t0 is greater than or equal to a time difference threshold (S307). If the difference is determined to be greater than or equal to a time difference threshold (S307: Yes), the determination unit 334 stores information that indicates a state switching time point in the determination result DB 322, in association with a corresponding recording ID (S308). Afterward, transfer to S309 is executed.

if the difference is determined to be less than a time difference threshold (S307: No), the determination unit 334 determines whether or not a difference between r1 and r0 is greater than or equal to a rotational speed difference threshold (S310). If the difference is determined to be greater than or equal to a rotational speed difference threshold (S310: Yes), the determination unit 334 transfers to S308. On the other hand, if the difference is less than a rotational speed difference threshold (S310: No), the determination unit 334 transfers to S309.

Then, the determination unit 334 determines, for example, whether or not an instruction for an end of a process is accepted from a non-illustrated terminal of a user (S309). If an instruction for an end of a process is determined not to be accepted (S309: No), the determination unit 334 returns to S301 to repeat such a process. On the other hand, if an instruction for an end of a process is determined to be accepted (S309: Yes), the determination unit 334 ends such a process.

Effect

A loaded/unloaded state determination program in the present embodiment further executes a process that measures a static time after a point of time when a vehicle is static and before a point of time when the vehicle starts to move, and if a static time is determined to be greater than or equal to a third threshold, the program causes a computer to execute a determination process. Thereby, if a static time is short and there is a low possibility of executing cargo loading or unloading, a process of determination of a loaded state or unloaded state of a vehicle is not executed, and hence, it is possible to reduce a processing load.

Furthermore, a loaded/unloaded state determination program in the present embodiment causes a computer to execute a process that measures a static time after a point of time when a vehicle is stopped and before a point of time when the vehicle starts to move. Furthermore, if a static time is determined to be greater than or equal to a third threshold, a loaded/unloaded state determination program causes a computer to execute a process that acquires a period of time until a vehicle reaches a predetermined vehicle speed that is acquired before such a static time reaches a predetermined vehicle speed. A loaded/unloaded state determination program causes a computer to execute a process that acquires a period of time that is acquired after such a static time until a vehicle reaches a predetermined vehicle speed, and compares the acquired period of time with a period of time that is acquired before such a static time until a vehicle reaches such a predetermined vehicle speed. Moreover, if a result of comparison is greater than a fourth threshold, a loaded/unloaded state determination program causes a computer to execute a process that determines that cargo loading or unloading happens in such a static time. Thereby, it is possible to accurately execute determination of a loaded state or unloaded state of a vehicle without presetting a threshold.

Moreover, if cargo loading or unloading happens, a loaded/unloaded state determination program in the present embodiment causes a computer to execute a process that acquires a period of time that is acquired before a static time until a vehicle reaches a predetermined vehicle speed. A loaded/unloaded state determination program causes a computer to execute a process that further acquires a period of time that is acquired after a static time until a vehicle reaches a predetermined vehicle speed. A loaded/unloaded state determination program causes a computer to execute a process that sets a first threshold by using a period of time that is acquired before a static time until a vehicle reaches a predetermined vehicle speed and a period of time until a vehicle reaches such a predetermined vehicle speed. Thereby, it is possible to appropriately set a threshold for determining a loaded state or unloaded state of a vehicle.

[d] Fourth Embodiment

Meanwhile, although embodiments of the present invention have been described so far, the present invention may be implemented in a variety of other different modes than the embodiments as described above. For example, although a configuration that uses a maximum rotational speed in an acceleration time as a rotational speed of an engine to be compared with a rotational speed threshold has been described, this does not limit the examples of configuration and a configuration may be provided that uses an average rotational speed of an engine in such an acceleration time.

Furthermore, for example, although a configuration of the loaded/unloaded state determination device 100 to acquire an acceleration time until a vehicle reaches a predetermined vehicle speed from a static state has been described in the first embodiment, this does not limit the example of configuration. For example, the loaded/unloaded state determination device 100 may be configured to acquire a period of time until a vehicle reaches a vehicle speed B (for example, 30 km/h) from a vehicle speed A (for example, 10 km/h) and compare each period of time with a time threshold. Furthermore, the loaded/unloaded state determination device 100 may be configured not to acquire an acceleration time of a vehicle but to acquire a period of time until a vehicle decelerates to a predetermined vehicle speed or a period of time until a vehicle is stopped.

Furthermore, although a configuration of the loaded/unloaded state determination device 100 to execute determination of a loaded state or unloaded state based on an acceleration time without executing determination of a length of a static time has been described in the first embodiment, this does not limit the example of configuration. For example, the loaded/unloaded state determination device 100 may be configured to execute determination of a loaded state or unloaded state if a static time is determined to be greater than or equal to a threshold, as in the case of the second embodiment.

Additionally, the vehicle speed acquisition unit 131 may be configured not to store an acceleration time after such an accelerate start in the determination result DB 122 if a vehicle decelerates or is stopped after stating to accelerate and before reaching a predetermined vehicle speed. Furthermore, the determination result DB 122 may be configured to store information indicating that the vehicle does not accelerate to a predetermined vehicle speed. Similarly, if the rotational speed acquisition unit 132 does not receive an input of determination showing that a vehicle speed is greater than or equal to a time threshold from the vehicle speed acquisition unit 131, the rotational speed acquisition unit 132 may be configured not to store a rotational speed of an engine in the determination result DB 122. Furthermore, the determination result DB 122 may be configured to store the result as not having accelerated to a predetermined vehicle speed.

Furthermore, although in the first embodiment it has been described that a configuration of the loaded/unloaded state determination device 100 does not execute determination of a length of a static time but executes determination of a loaded state or unloaded state based on an acceleration time, this does not limit the example of configuration. For example, the loaded/unloaded state determination device 100 may be configured to execute determination of a loaded state or unloaded state if a static time is determined to be greater than or equal to a threshold, as in the case of the second embodiment.

Furthermore, although a configuration of the loaded/unloaded state determination device 200 to reset a threshold based on a gradient has been described in the second embodiment, this does not limit the example of configuration. For example, the loaded/unloaded state determination device 200 may be configured to reset a threshold based on another condition such as a whether condition or a road surface condition.

Furthermore, the spot DB 223 of the loaded/unloaded state determination device 200 may further store information regarding a caution area where an alert to a driver is preferable, such as spots where accidents happens more frequently than other spots, and may further include a warning unit that executes warning when approaching such a caution area. In such a case, a warning unit of the loaded/unloaded state determination device 200 determines whether a vehicle that is approaching such a caution area is loaded or not, and executes warning for such a vehicle only if the vehicle is determined to be loaded.

For example, the loaded/unloaded state determination device 100 may be configured to further include a fuel efficiency calculation unit that calculates a fuel efficiency of a vehicle, where the fuel efficiency calculation unit calculates a fuel efficiency based on whether a vehicle is loaded or not.

Although an example in each of the above-mentioned embodiments has been described in such a manner that a vehicle ID is provided to an individual vehicle and a “time threshold” and a “rotational speed threshold” are individually set for each vehicle, this does not limit the example of configuration. For example, a configuration may be provided in such a manner that a vehicle ID is set for each type of vehicle, that is, a time threshold and a rotational speed threshold that correspond to an identical vehicle ID are applied to a plurality of vehicles with an identical type of vehicle. Furthermore, a vehicle ID may be configured to be set for each classification of a vehicle such as a large size, a middle size, or a small size.

Furthermore, each component of each device as illustrated in the drawings is functionally conceptual and is not necessarily needed to be physically configured as illustrated in the drawings. That is, a specific embodiment of dispersion or integration of respective devices is not limited to those illustrated in the drawings. That is, it is possible to provide a configuration in such a manner that its entirety or part is functionally or physically dispersed or integrated in an arbitrary unit, depending on a variety of loads, a usage, or the like. For example, the vehicle speed acquisition unit 131 and the rotational speed acquisition unit 132 may be integrated. Moreover, for each processing function that is executed in each device, its entirety or any part thereof is able to be realized by a CPU and a program that is analyzed and executed by such a CPU or is able to be realized as hardware based on a wired logic.

Hardware Configuration

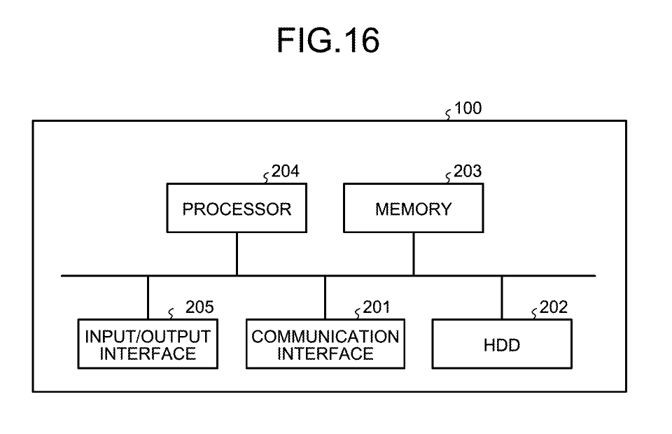

FIG. 16 is a diagram illustrating a hardware configuration example of a loaded/unloaded state determination device. Additionally, although the loaded/unloaded state determination device 100 in the first embodiment will be described as an example below, the loaded/unloaded state determination device 200 in the second embodiment and the loaded/unloaded state determination device 300 in the third embodiment are also realizable by a similar hardware configuration. As illustrated in FIG. 16, the loaded/unloaded state determination device 100 includes a communication interface 201, a Hard Disk Drive (HDD) 202, a memory 203, a processor 204, and an input/output interface 205.

The communication interface 201 corresponds to the communication unit 111 as illustrated with a description of each functional unit, and is, for example, a network interface card or the like. The HDD 202 stores a program that causes a processing unit as illustrated with a description of each functional unit to operate, a DB, or the like.

The processor 204 reads a program that executes a process similar to the process of each processing unit as illustrated with a description of each functional unit from the HDD 202 or the like, and extracts the program on the memory 203, and thereby, operates a process that executes each function as illustrated in FIG. 3 or the like. In other words, such a process executes functions similar to those of the vehicle speed acquisition unit 131, the rotational speed acquisition unit 132, and the determination unit 133 that are included in the loaded/unloaded state determination device 100. The input/output interface 205 corresponds to the input/output unit 112 as illustrated with a description of each functional unit.

Thus, the loaded/unloaded state determination device 100 operates as an information processing device that executes a loaded/unloaded state determination method by reading and executing a program. Furthermore, the loaded/unloaded state determination device 100 can realize a function similar to those of the above-mentioned embodiments by reading the above-mentioned program from a recording medium by a medium reading device and executing the above-mentioned read program. Additionally, a program that is mentioned in another embodiment is not limited to the program to be executed by the loaded/unloaded state determination device 100. For example, it is also possible to similarly apply the present invention if another computer or server executes a program, or if some of these computers and servers cooperate to execute a program.

According to an aspect, it is possible to determine a loaded state or unloaded state of a vehicle accurately.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a loaded/unloaded state determination program that causes a computer to execute a process comprising:
acquiring a period of time until a vehicle reaches a predetermined vehicle speed from a first vehicle speed; and
determining that a cargo is loaded on the vehicle if the acquired period of time satisfies a predetermined condition.

2. The non-transitory computer-readable recording medium according to claim 1, wherein the first vehicle speed is a vehicle speed where it is possible to regard a vehicle as static thereof, and the determining includes
comparing a period of time until the vehicle reaches a predetermined vehicle speed from the first vehicle speed with a first threshold and
determining that the predetermined condition is satisfied if the period of time is greater than or equal to the first threshold.

3. The non-transitory computer-readable recording medium according to claim 2, wherein the determining includes
determining that the predetermined condition is satisfied if a rotational speed of an engine within a period of time until the vehicle reaches a predetermined vehicle speed from the first vehicle speed is greater than or equal to a second threshold even if the period of time is less than the first threshold.

4. The non-transitory computer-readable recording medium according to claim 3, wherein the process further comprises:
identifying a gradient of a distance from a position where the vehicle is static to a predetermined spot where the vehicle passes therethrough; and
changing the first threshold or the second threshold based on the identified gradient.

5. The non-transitory computer-readable recording medium according to claim 4, wherein the process further comprises
measuring a static time after a point of time when the vehicle is stopped and before a point of time when the vehicle starts to move, wherein
the determining is executed if the measured static time is determined to be greater than or equal to a third threshold.

6. The non-transitory computer-readable recording medium according to claim 5, wherein the process further comprises:
measuring a static time after a point of time when the vehicle is stopped and before a point of time when the vehicle starts to move;
comparing a period of time unit the vehicle reaches a predetermined vehicle speed that is acquired before the static time with a period of time until the vehicle reaches a predetermined vehicle speed that is acquired after the static time if the measured static time is determined to be greater than or equal to a third threshold; and
determining that cargo loading or unloading for the vehicle is executed within the static time if a result of the comparing is greater than a fourth threshold.

7. The non-transitory computer-readable recording medium according to claim 6, wherein the process further comprises
setting the first threshold by using a period of time until the vehicle reaches a predetermined vehicle speed that is acquired before the static time and a period of time until the vehicle reaches a predetermined vehicle speed that is acquired after the static time if the cargo loading or unloading is determined to be executed.

8. The non-transitory computer-readable recording medium according to claim 1, wherein the process further comprises
providing a warning a cargo is determined to be loaded on the vehicle when the vehicle approaches a caution area where an alert to a driver is preferable that is stored in a caution area storage unit.

9. A loaded/unloaded state determination method, wherein a computer executes a process comprising:
acquiring a period of time until a vehicle reaches a predetermined vehicle speed from a first vehicle speed; and
determining that a cargo is loaded on the vehicle if the acquired period of time satisfies a predetermined condition.

10. A loaded/unloaded state determination device, comprising a processor that executes a process including:
acquiring a period of time until a vehicle reaches a predetermined vehicle speed from a first vehicle speed,
determining that a cargo is loaded on the vehicle if the acquired period of time satisfies a predetermined condition; and
outputting result of the determining.
